(19) United States
(12) Patent Application Publication
(10) Pub. No.: US 2015/0213388 A1
(43) Pub. Date: Jul. 30, 2015

(54) CONSENSUS BUILDING SUPPORT METHOD, CONSENSUS BUILDING SUPPORT APPARATUS, AND CONSENSUS BUILDING SUPPORT SYSTEM

(71) Applicant: FUJITSU LIMITED, Kawasaki-shi (JP)

(72) Inventors: Satoshi Munakata, Kawasaki (JP); Yuji Mizobuchi, Kawasaki (JP); Kuniharu Takayama, Tama (JP)

(73) Assignee: FUJITSU LIMITED, Kawasaki-shi (JP)

(21) Appl. No.: 14/573,844

(22) Filed: Dec. 17, 2014

(30) Foreign Application Priority Data
Jan. 28, 2014 (JP) 2014-013607

(51) Int. Cl. G06Q 10/06

(52) U.S. Cl. CPC G06Q 10/06316

(57) ABSTRACT

A consensus building support method includes: acquiring information related to one or more elements that affect a plurality of evaluations for each of a plurality of candidates for an alternative plan which includes at least one element and corresponds to a target of a consensus building; calculating, by a computer, an influence degree of the plurality of evaluations for each of the one or more elements based on the plurality of evaluations and the information; and creating corrected candidates by adding or removing a selected element which is selected based on the influence degree for each of the one or more elements to or from one of the plurality of candidates.

### CROSS-REFERENCE TO RELATED APPLICATION

This application is based upon and claims the benefit of priority from the prior Japanese Patent Application No. 2014-013607 filed on Jan. 28, 2014, the entire contents of which are incorporated herein by reference.

### FIELD

The embodiments discussed herein are related to a consensus building support method, a consensus building support apparatus, and a consensus building support system.

### BACKGROUND

A common process to perform work in an organization is established under the consensus of each member of the organization. When values related to the work are different from each other between members, a large number of man-hours are demanded until consensus building is completed.

Related arts are disclosed in Saaty, Thomas L., “How to make a decision: the analytic hierarchy process”, European journal of operational research 48.1 (1990), pp. 9-26, Yoshiyasu Yamada, Manabu Sugiyama, Naokazu Yamaki, “Group AHP using consensus building model”, Journal of the Operations Research Society of Japan 40.2 (1997), pp. 236-244, or Shinei Takano, Soshi Suzuki, “Research for consensus building support system using alternative plan correction vector method”, Miscellany of Japan Society of Civil Engineers 716 (2002), pp. 1-10.

### SUMMARY

According to an aspect of the embodiments, a consensus building support method includes: acquiring information related to one or more elements that affect a plurality of evaluations for each of a plurality of candidates for an alternative plan which includes at least one element and corresponds to a target of a consensus building; calculating, by a computer, an influence degree of the plurality of evaluations for each of the one or more elements based on the plurality of evaluations and the information; and creating corrected candidates by adding or removing a selected element which is selected based on the influence degree for each of the one or more elements to or from one of the plurality of candidates.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a consensus building support apparatus;

FIG. 2 illustrates an example of a process;

FIG. 3 illustrates an example of a data structure of a process instance;

FIG. 4 illustrates an example of acquisition of a process;

FIG. 5 illustrates an example of extraction of a task;

FIG. 6 illustrates an example of readjustment of a task;

FIG. 7 illustrates an example of a survey screen;

FIG. 8 illustrates an example of importance degree information;

FIG. 9 illustrates an example of calculation of an evaluation value;

FIG. 10 illustrates an example of calculation of the evaluation value;

FIG. 11 illustrates an example of calculation of influence degree;

FIG. 12 illustrates an example of calculation of influence degree;

FIG. 13 illustrates an example of calculation of influence degree;

FIG. 14 illustrates an example of calculation of influence degree;

FIG. 15 illustrates an example of calculation of influence degree of evaluation;

FIG. 16 illustrates an example of an alternative plan correction vector;

FIG. 17 illustrates an example of selection of a target plan to be corrected;

FIG. 18 illustrates an example of a corrected alternative plan;

FIG. 19 illustrates an example of a consensus building support apparatus;

FIG. 20 illustrates an example of a consensus building support process;

FIGS. 21A and 21B are examples of degree of influence of evaluation; and

FIG. 22 illustrates an example of a corrected alternative plan.

### DESCRIPTION OF EMBODIMENT

A consensus building support method may include an analytic hierarchy process (AHP) and a method of using the AHP. In the AHP, values for an issue which is desired to be agreed between members are mathematically analyzed based on a questionnaire survey, and thus differences in the values and the degree of importance of an alternative plan are digitized. In the AHP, for example, an alternative plan having the highest degree of importance is set to an alternative plan in which consensus has been acquired between the members.

In the AHP, the degree of importance of each of the alternative plans is digitized while it is assumed that the alternative plan is prepared in advance without omission. However, when a common process is actually prepared, consensus building is performed while the alternative plan is corrected. Therefore, the consensus building is performed using the AHP while a plurality of people correct the alternative plan. When the consensus building is being performed, a corrected alternative plan which increases the degree of satisfaction of the members is created, and an alternative plan of the highest degree of satisfaction is studied. In addition, an alternative plan correction vector is used as an index, which indicates the degree of change in an evaluation value of each of the evaluation items for the alternative plan acquired before and after the correction is performed, such that dissatisfaction for the most important alternative plan of each of a plurality of different groups are decreased.

For example, the correction of the alternative plan using the alternative plan correction vector is progressed with a plurality of people conferring with each other, and thus many man-hours may be demanded with trial and error.

For example, when a common work process is established between the plurality of members, a consensus building support apparatus, which suggests the candidates for an alternative plan in order to support consensus building between the members, may be used.

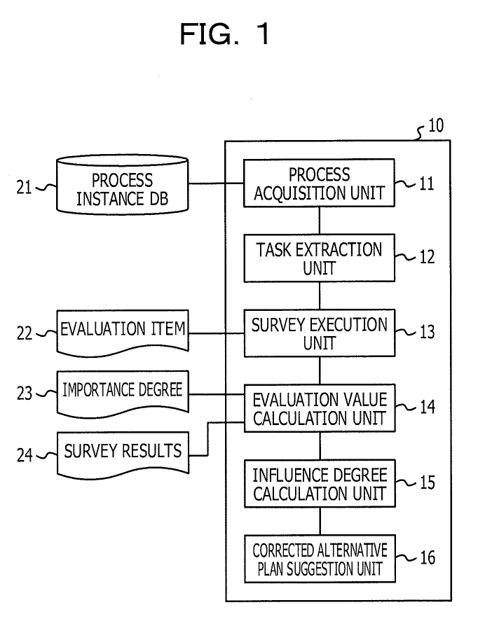

FIG. 1 illustrates an example of a consensus building support apparatus. The consensus building support apparatus 10 illustrated in FIG. 1 includes a process acquisition unit 11, a task extraction unit 12, a survey execution unit 13, an evaluation value calculation unit 14, an influence degree calculation unit 15, and a corrected alternative plan suggestion unit 16.

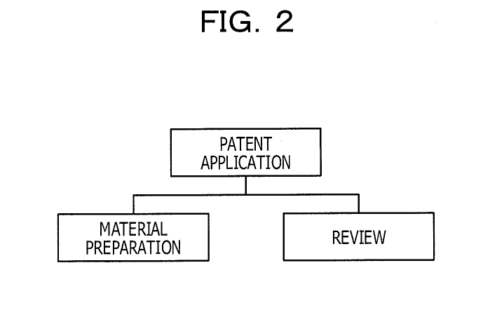

The process acquisition unit 11 acquires a process instance, which indicates a work process for commonization, from a process instance database (DB) 21. The process instance may include at least one task. FIG. 2 illustrates an example of a process. FIG. 2 illustrates the process which is expressed using a tree structure of tasks. For example, as illustrated in FIG. 2, each of the tasks includes one parent task, and the process instance is expressed as the tree structure of the tasks. The tasks may be generated based on a task name or a task pattern where which task is used as the parent task is determined in advance.

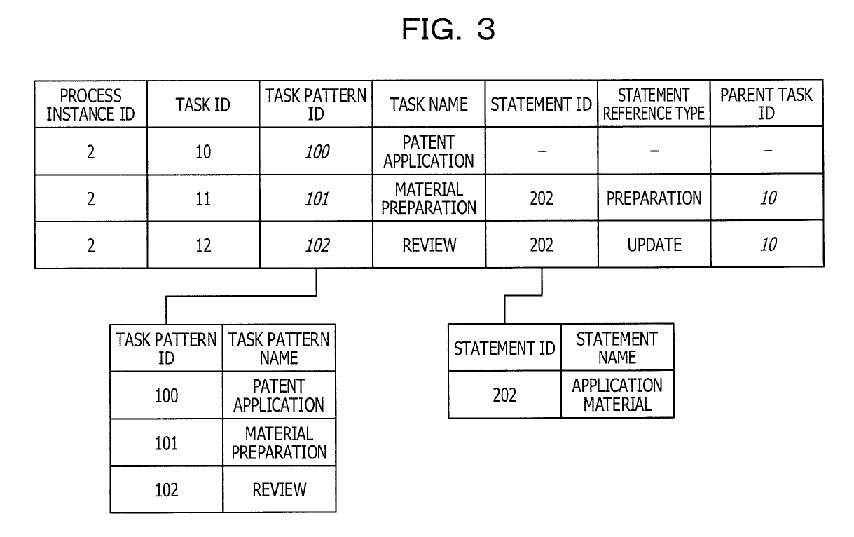

The process instance may be acquired from a log generated when work is performed using a dynamic workflow. For example, a process related to patent application work may be set to a subject to be processed. FIG. 3 illustrates an example of a data structure of a process instance. In FIG. 3, the process instance includes information of a process instance ID which identifies each of the process instances, a task ID which identifies a task included in each of the process instances, a pattern ID of each of the tasks, and a task name. The process instance further includes information of a statement ID which identifies a statement (including a material, a form, and the like) used for each of the tasks, a statement reference type which indicates a process (to prepare, refer to, update, remove and the like) performed on the statement identified by the statement ID, and a parent task ID which indicates the task ID of the parent task.

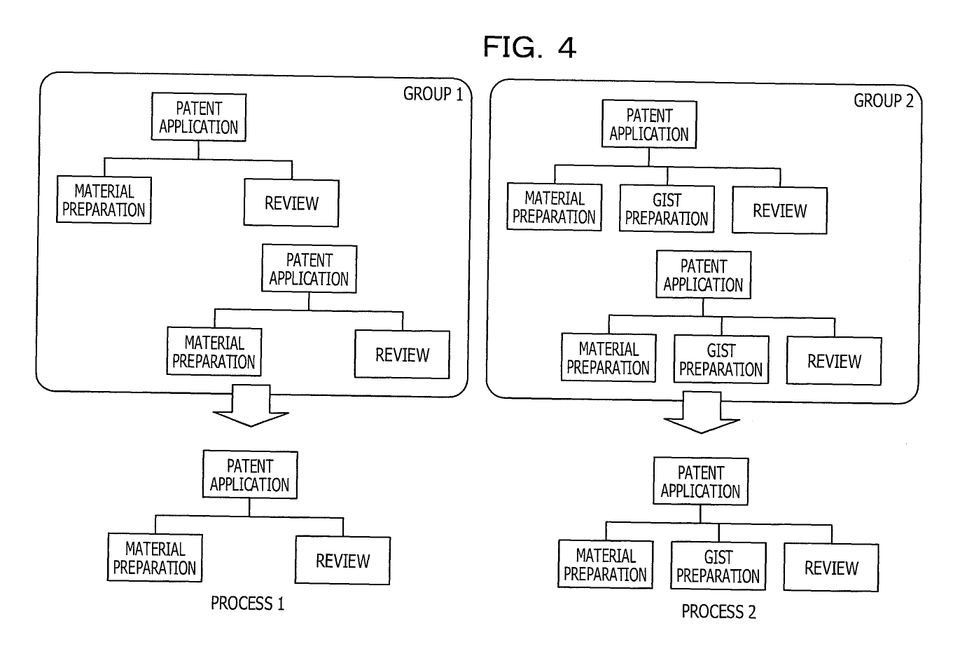

FIG. 4 illustrates an example of acquisition of process. The process acquisition unit 11 groups a plurality of acquired process instances for the respective process instances, which have the same type tree structure of tasks, and acquires processes from each of the groups one by one as illustrated in FIG. 4.

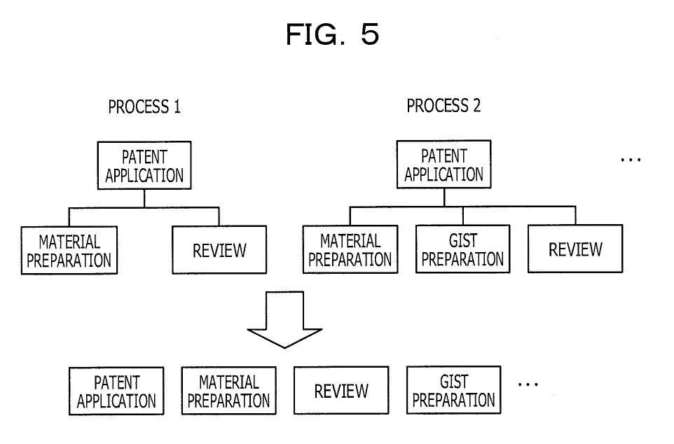

FIG. 5 illustrates an example of extraction of a task. The task extraction unit 12 disassembles the plurality of processes acquired by the process acquisition unit 11 for each of the tasks, removes overlapping tasks, and extracts tasks which are included in the plurality of processes, as illustrated in FIG. 5.

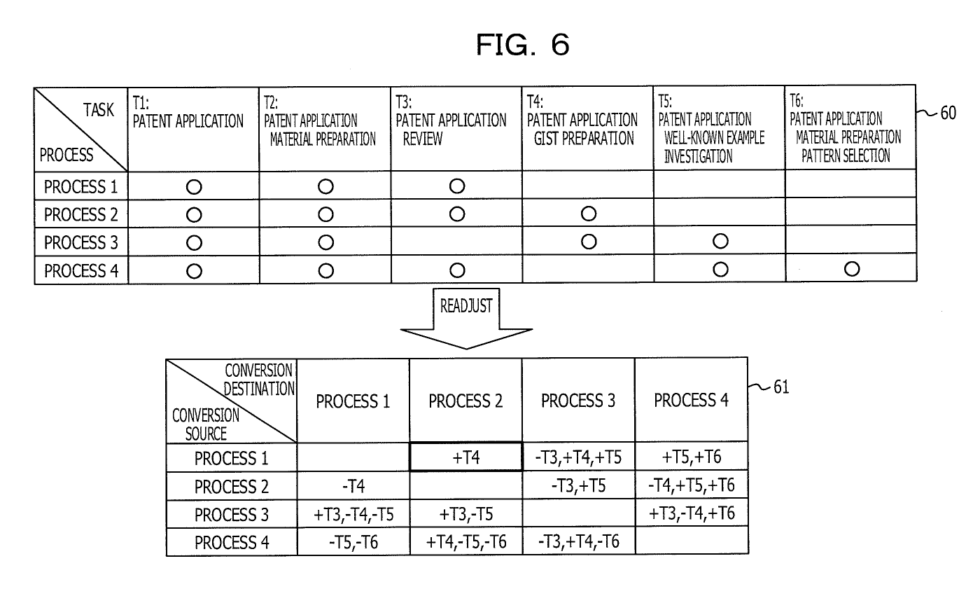

FIG. 6 illustrates an example of readjustment of a task. The task extraction unit 12 readjusts tasks included in each of the processes as in a table 60 illustrated in FIG. 6, and readjusts different tasks in each of the processes as in table 61 illustrated in FIG. 6. In the table 60, a child task is written after being indented by one character under a parent task. Each cell of the table 61 illustrates a way to add or remove which task to or from a process corresponding to the row of the cell so that the process corresponding to the row of the cell is converted into a process corresponding to the column of the cell. For example, in a cell of the table 61, which is surrounded by a thick frame, it is illustrated that a task T4 (patent application-gist preparation) is added to a process 1 such that the process 1 is converted into a process 2.

The survey execution unit 13 sets the processes acquired by the process acquisition unit 11 to the candidates for an alternative plan which is a consensus building subject, and executes a survey in order to acquire evaluation for each of the plurality of candidates. The survey execution unit 13 executes a survey in order to acquire information about tasks, which affect the evaluation for each of the plurality of candidates, while executing the survey in order to acquire the evaluation for each of the plurality of candidates.

For example, the survey execution unit 13 acquires information 22 about evaluation items for evaluating each of the candidates. For example, the evaluation items may include “rapidity”, “reliability”, and “educational property”. The survey execution unit 13 selects processes which are used as the candidates for the alternative plan. All or some of the processes acquired by the process acquisition unit 11 may be the processes which are used as the candidates for the alternative plan. When some of the processes acquired by the process acquisition unit 11 are selected as the candidates for the alternative plan, a process which includes the tasks extracted by the task extraction unit 12 may be selected. For example, the process 1, a process 3, and a process 4 may be selected from among the processes 1 to 4 illustrated in the table 60 of FIG. 6.

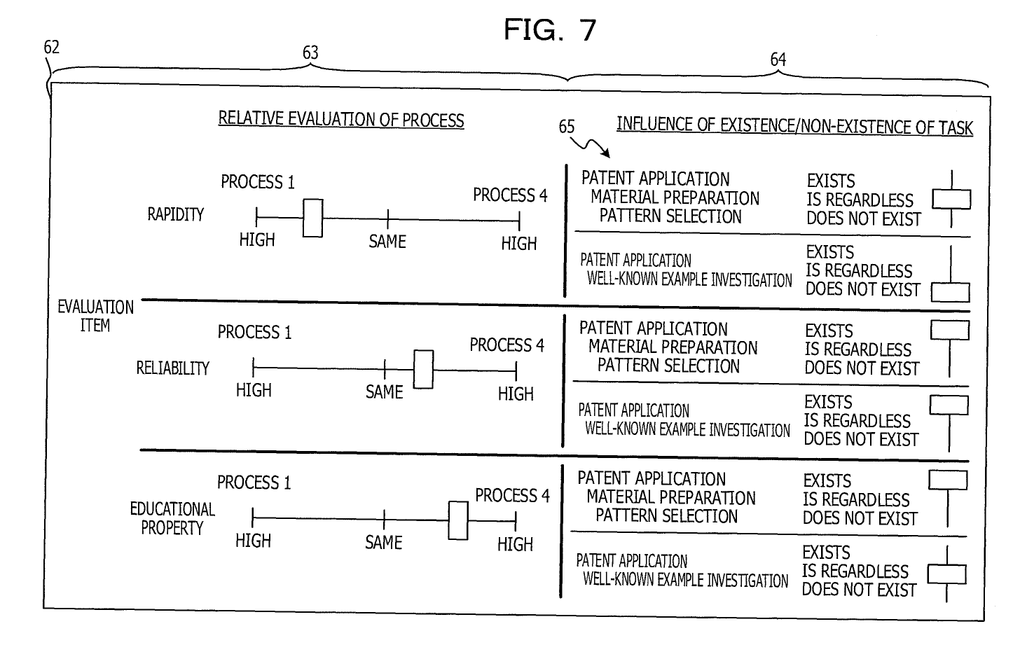

FIG. 7 illustrates an example of a survey screen. The survey execution unit 13 performs control such that a survey screen 62 as illustrated in FIG. 7 is displayed on a display apparatus which may be used by members who perform the consensus building.

The survey screen 62 illustrated in FIG. 7 includes a survey area 63 for acquiring evaluation for each of the plurality of candidates, and a survey area 64 for acquiring information about the tasks which affect the evaluation for each of the plurality of candidates. In the survey area 63, the survey results of a relative evaluation for each of the evaluation items between two processes selected as the candidates from among the processes are received. In the survey area 64, the survey results, which indicate whether or not a fact that different tasks between two processes (refer to reference numeral 65 in FIG. 7) exist or do not exist in one process (existence/non-existence) of task affects determination of the relative evaluation, are received. The survey execution unit 13 acquires the different tasks between two processes from information readjusted by the task extraction unit 12 as illustrated in, for example, the table 61 of FIG. 6.

In the survey screen 62 illustrated in FIG. 7, answers may be given by moving slide bars. Members who answer the survey input the answers for the survey by moving the slide bars using an input apparatus.

As above, since the survey performed in order to acquire evaluation for each of the plurality of candidates and the survey performed in order to acquire information about tasks which affect the evaluation for each of the plurality of candidates are substantially performed simultaneously, the burden on the members may be reduced. The survey screen 62 of FIG. 7 is an example, and may be appropriately modified according to an evaluation method and an answer method.

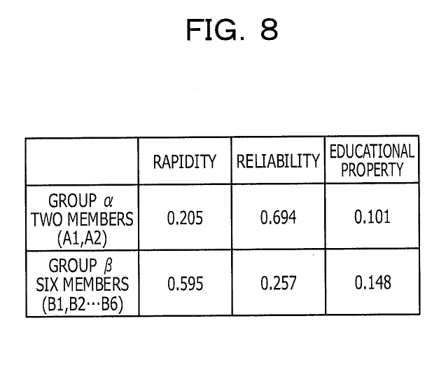

The evaluation value calculation unit 14 acquires importance degree information 23 and the survey results 24, and calculates the evaluation value for each of the processes selected as the candidates for the alternative plan. The importance degree information 23 may be, for example, information which is determined in advance using the AHP or the like. The importance degree information 23 may be determined using a method of the related art. For example, when a common process is established, the members are grouped based on the values of the respective members about emphasis is placed on which evaluation item. The degree of importance for each of the evaluation items of the respective members who belong to each of the groups are averaged, and the averaged importance is set to the importance for each of the evaluation items of each of the groups. FIG. 8 illustrates an example of importance degree information. In FIG. 8, the members are divided into a group a and a group 13 based on the difference in the importance for each of the evaluation items.

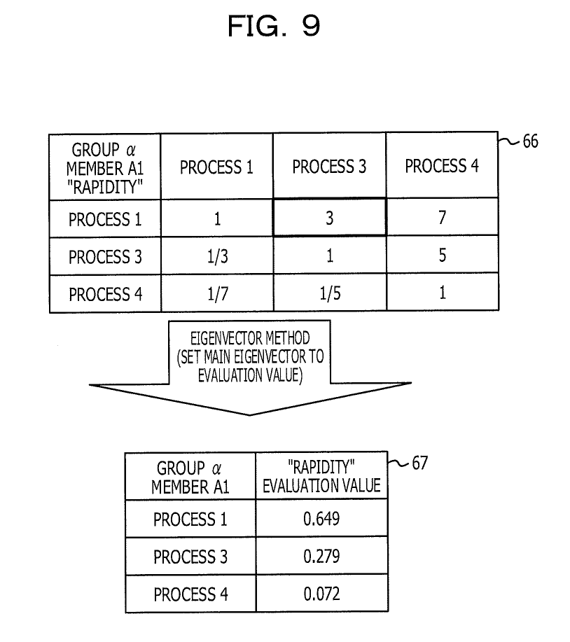

FIG. 9 illustrates an example of calculation of an evaluation value. The evaluation value calculation unit 14 acquires the evaluation of each of the members for each of the plurality of candidates as the survey results 24, and calculates the evaluation values for each of the processes for each of the evaluation items for each of the members. For example, the evaluation value calculation unit 14 uses, for example, the AHP method, and prepares a pairwise comparison matrix 66, which expresses the relative evaluation between the processes for the evaluation item “rapidity”, based on the survey results prepared by a member A1 who belongs to the group α, as illustrated in FIG. 9. The pairwise comparison matrix 66 is a matrix which indicates evaluation of a process corresponding to the row of each of the cells (each of the components of the matrix) is how many times higher than that of the process corresponding to the column of the cell. For example, a cell, which is surrounded by a thick frame in the pairwise comparison matrix 66 of FIG. 9, indicates that “the evaluation for the evaluation item “rapidity” of the member A1 of the group α is three times higher in the process 1 than the process 3”.

The evaluation value calculation unit 14 calculates the main eigenvector of the pairwise comparison matrix 66 using, for example, an eigenvector method. The main eigenvector is set to evaluation values 67 for the respective processes for the evaluation item “rapidity” performed by the member A1 of the group α, as illustrated in FIG. 9. The evaluation value calculation unit 14 similarly calculates the evaluation values for the respective processes for the evaluation item “rapidity” performed by each of the members of the group α, and averages the evaluation values. The averaged evaluation value is set to an evaluation value for the respective processes for the evaluation item “rapidity” of the group α. The evaluation value calculation unit 14 similarly calculates the evaluation values for the respective processes for another evaluation item.

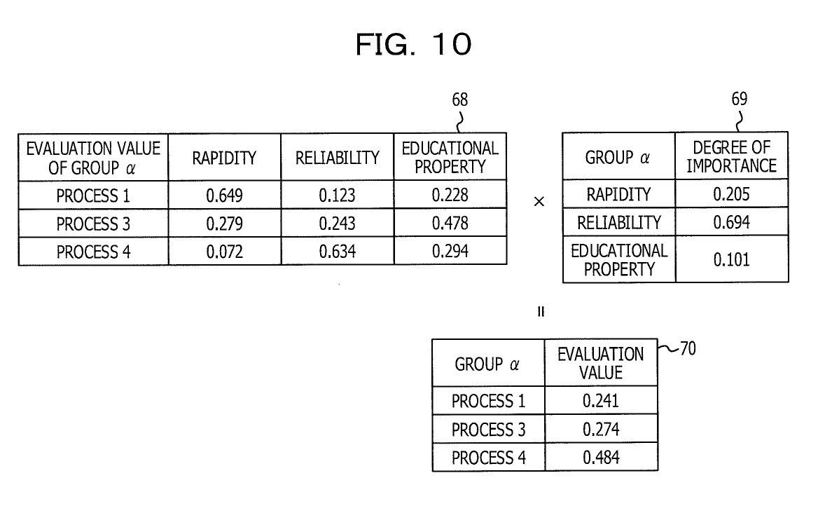

FIG. 10 illustrates an example of calculation of an evaluation value. The evaluation value calculation unit 14 calculates a matrix product of each of the evaluation values 68 for each of the processes for each of the evaluation items of the group α and importance degree 69 for each of the evaluation items of the group α acquired from the importance degree information 23, as illustrated in FIG. 10. The evaluation value calculation unit 14 sets each of the components of the matrix product set to an evaluation value 70 for each of the processes of the group α.

The influence degree calculation unit 15 calculates the influence degree for each of the tasks. The influence for each of the tasks may be an index which indicates the direction and the magnitude of change in the evaluation value of each of the evaluation items when a certain task is added to or removed from a certain process. In order to change the evaluation value of each of the evaluation items for a process, which is a correction target, in a desired direction and to the desired magnitude, which task to be added to the process or which task to be removed from the process is determined by that the influence for each of the tasks is appropriately calculated.

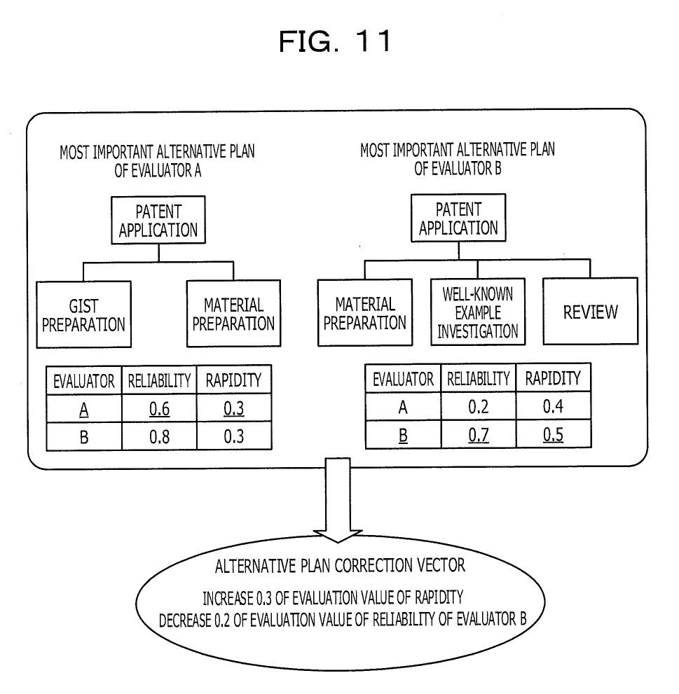

FIG. 11 illustrates an example of a calculation of influence degree. For example, the influence for each of the tasks may be applied in a method using the AHP and the alternative plan correction vector. When respective processes, which are the alternative plans prepared by evaluators A and B, are evaluated, for example, the most important alternative plans (alternative plans which have the highest evaluation values) of the respective evaluators are determined as illustrated in FIG. 11. In this case, in order to achieve consensus building between the evaluator A and the evaluator B, a corrected alternative plan acquired by correcting the most important alternative plan of the evaluator A may be prepared. For example, the most important alternative plan of the evaluator A is set to a target plan to be corrected, and the alternative plan correction vector is demanded to correct the target plan to be corrected in a direction that satisfies the evaluator B. For example, with regard to an evaluation value for the target plan to be corrected (the most important alternative plan of the evaluator A) set by the evaluator B, an alternative plan correction vector is demanded which indicates change such that the evaluation value of the evaluation item “rapidity” is increased by 0.3 and the evaluation value of the evaluation item “reliability” is reduced by 0.2.

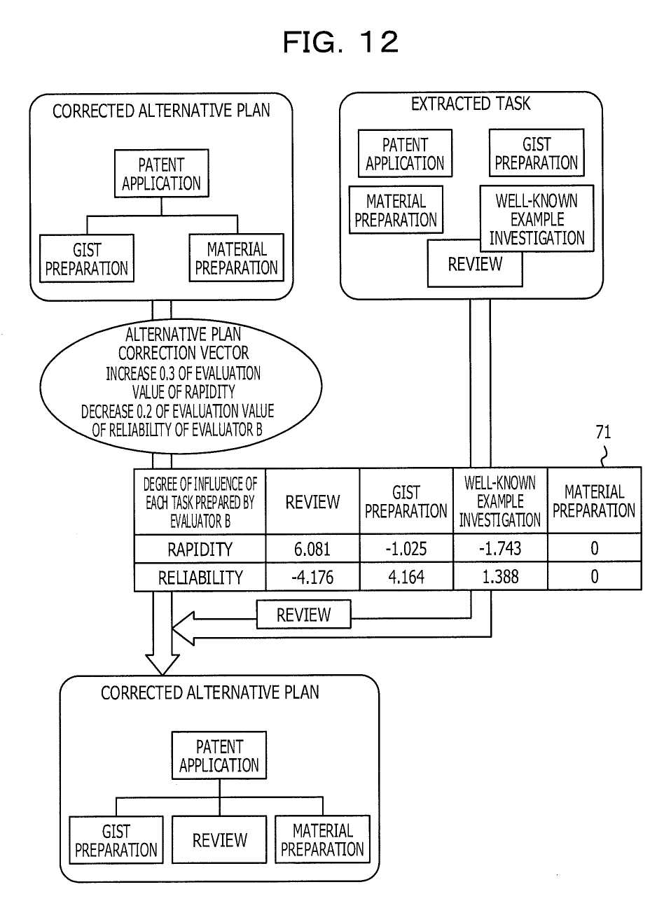

FIG. 12 illustrates an example of calculation of influence degree. As illustrated in FIG. 12, a task, which has the change in the evaluation value becomes close to the direction and magnitude indicated by the alternative plan correction vector when addition or removal is performed on the target plan to be corrected, is selected based on the influence 71 of the evaluator B for each of the tasks. In FIG. 12, regarding the influence 71 of the evaluator B for each of the tasks, rapidity increases or decreases at a rate of +6.018 and reliability increases or decreases at a rate of −4.176 if, for example, a task “review” is added to a certain process. Based on the influence 71 of the evaluator B for each of the tasks, the task “review” which causes the change close to the alternative plan correction vector is selected, and thus a corrected alternative plan, in which the task “review” is added to the target plan to be corrected, is prepared.

The influence degree for each of the tasks is appropriately calculated in order to prepare the corrected alternative plan. However, there may be a case in which it is difficult to appropriately calculate the influence degree for each of the tasks. For example, a representative method, which is used when estimating influence which is given, by each of the components of a plurality of compositions, to the evaluation values of the plurality of compositions, includes multiple regression analysis. When multiple regression analysis is applied, “the evaluation value of an alternative plan (process)” is set to an objective variable (quantity variable), the “existence/non-existence of task” is set to an explanatory variable (qualitative variable), and thus an influence may be modeled as the coefficient of the explanatory variable.

The number of samples (=the number of evaluated processes) may be greater than the number of explanatory variables (=the number of tasks) in order to apply the multiple regression analysis. For example, as illustrated in FIGS. 11 and 12, when the corrected alternative plan is prepared, the number of processes<<the number of tasks is established, and thus the multiple regression analysis may not be applied. In addition, evaluation is performed on a large number of processes in order to increase the number of samples, and thus the load on the members may increase. For example, the increase in the number of samples due to the execution of the survey performed on people other than the members may not be appropriate when the members establish the common work processes.

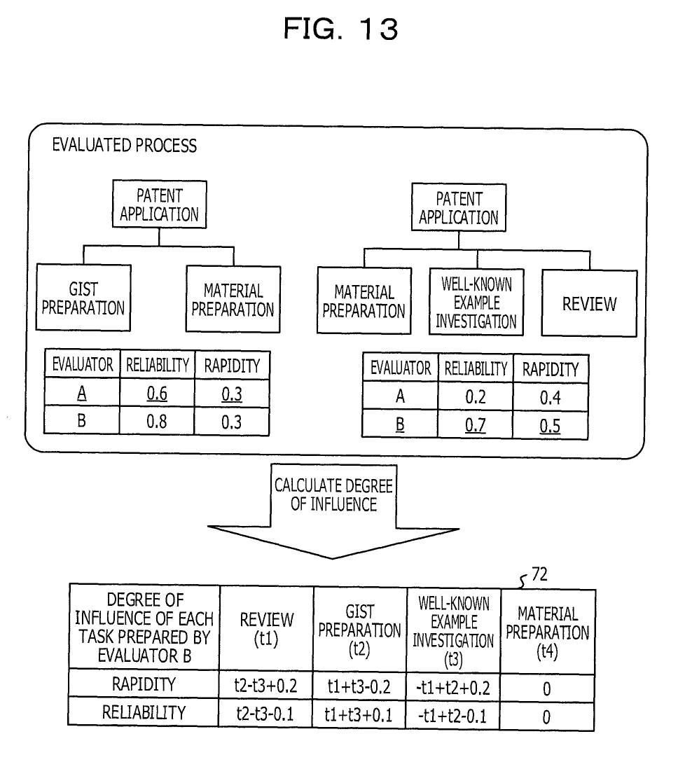

The acquisition of the influence degree for each of the tasks based on only the evaluation value of each of the alternative plans (processes) may be limited. For example, the influence degree for each of the tasks is acquired using an algebraic equation in which the influence degree for each of the tasks is a solution. FIG. 13 is an example of calculation of influence degree. For example, between two processes illustrated in FIG. 13, there is difference in existence and non-existence of three tasks “gist preparation”, “well-known example investigation”, and “review”. In contrast, evaluation values for the two processes are acquired. In a case of the number of evaluated processes<the number of tasks, the estimation of a solution using the algebraic equation may not be performed. For example, the influence of the task “review” is set to “t1”, the influence of the task “gist preparation” is set to “t2”, the influence of the task “well-known example investigation” is set to “t3”, and the influence of the task “material preparation” is set to “t4”. In this case, as illustrated in a table 72 of FIG. 13, the influence degree for each of the tasks is indicated as a relationship with the influence of another task. Therefore, the directivity (positive or negative) of the influence degree for each of the tasks may be indefinite. Therefore, a corrected alternative plan, to which small change is added such that a task is added or removed one by one, may not be examined.

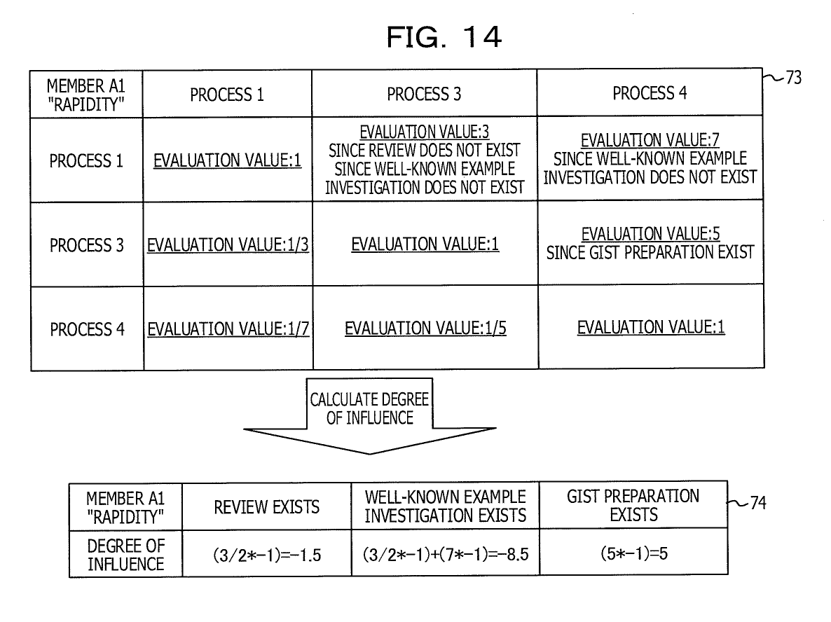

For example, the influence degree calculation unit 15 calculates the influence degree for each of the tasks as illustrated below. As the survey result 24, the influence degree calculation unit 15 acquires information about tasks, which affect the evaluation for each of the plurality of candidates of each of the members. For example, information related to a task which affects evaluation is added to the pairwise comparison matrix 66 which expresses the relative evaluation between each of the processes for the evaluation item “rapidity” of a member A1 who belongs to the group α as illustrated in FIG. 9, and a matrix 73 as illustrated in FIG. 14 is prepared. A cell (component of the matrix), which is surrounded by a thick frame in the matrix 73, indicates that “the process 1 does not include the task “well-known example investigation” and thus the evaluation of the evaluation item “rapidity” in the process 1 is 7 times higher than that in the process 4”.

The influence degree calculation unit 15 calculates the influence degree of a task Tₖ by the member A1 using, for example, Equation (1) below.

$$Degree of {influence}_{A 1} ( {T}_{k} ) = {\sum }_{i , j ∈ \{ i , j \vert {w}_{i , j} ( T 1 ) \neq 0 \}} ( {w}_{i , j} ( {T}_{k} ) \cdot \frac{Evaluation {value}_{i , j}}{{s}_{i , j}} ) \\ ∵ {s}_{i , j} = \vert \{ d \vert d ∈ {T}_{all} , {w}_{i , j} ( d ) \neq 0 \} \vert , \\ {w}_{i , j} ( {T}_{k} ) = \{ \begin{matrix}+ 1 & Since “ T 1 is exist ” in i \text{-} th row and j \text{-} th column \\ \pm 0 & Since “ T 1 is regardless ” in i \text{-} th row and j \text{-} th column \\ - 1 & Since “ T 1 is not exist ” in i \text{-} th row and j \text{-} th column\end{matrix} \qquad ( 1 )$$

k is k=1, 2, . . . , and K, and K indicates the number of tasks which are extracted by the task extraction unit 12. Tₐₗₗ indicates all of the tasks, for example, T₁, T₂, . . . , T_{K}.

FIG. 14 illustrates an example of calculation of influence degree. At the lower portion of the FIG. 14, the influence degree for each of the tasks 74 for evaluation item “rapidity” in a member A1, which is calculated based on the matrix 73 using Equation (1), is illustrated. The influence degree calculation unit 15 calculates and averages the influence degree for each of the tasks for the evaluation item “rapidity” in each of the members of the group α. The averaged influence degree is set to the influence degree for each of the tasks for the evaluation item “rapidity” of the group α. The influence degree calculation unit 15 calculates the influence degree for other evaluation items in the same manner.

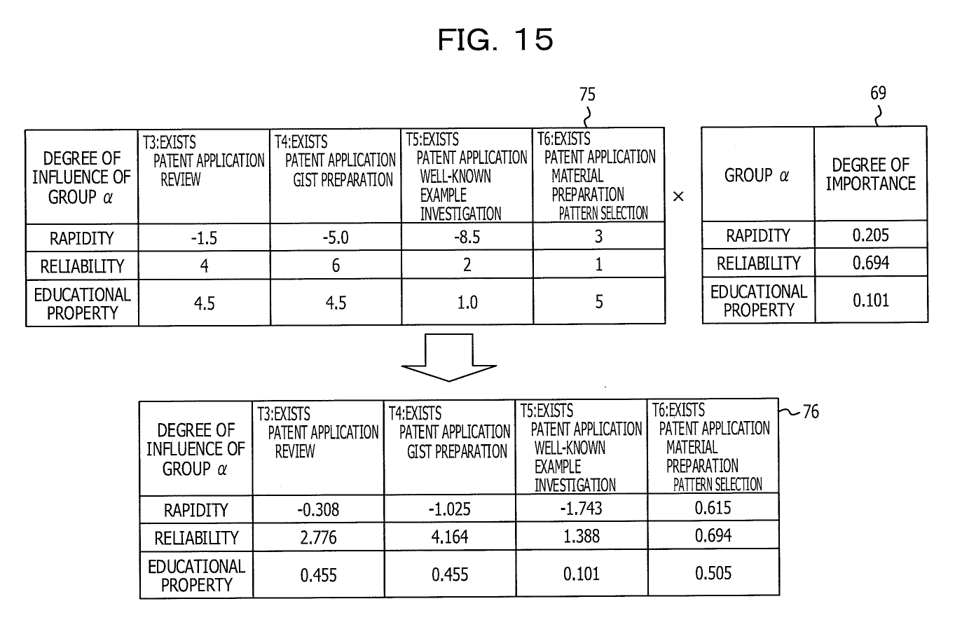

FIG. 15 illustrates an example of calculation of influence degree of evaluation. As illustrated in FIG. 15, the influence degree calculation unit 15 multiplies each of the values of the influence degree for each of the tasks 75 for each of the evaluation items of the group α by the importance degree of a corresponding evaluation item from among the importance degree 69 for each of the evaluation items of the group α acquired from the importance degree information 23. The influence degree calculation unit 15 sets the result of multiplication to evaluation influence degree 76 for each of the processes of the group α.

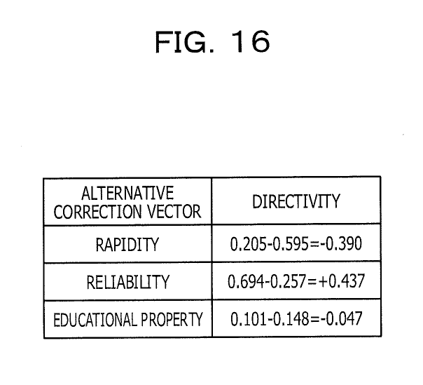

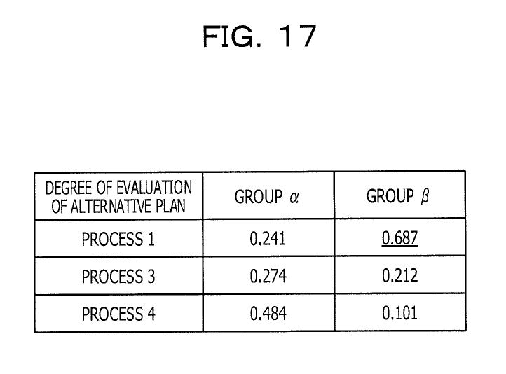

The corrected alternative plan suggestion unit 16 calculates the alternative plan correction vector using, for example, the importance degree information 23 as illustrated in FIG. 8. The alternative plan correction vector may be calculated using a method using a conventional method. FIG. 16 illustrates an example of an alternative plan correction vector. The corrected alternative plan suggestion unit 16 selects an alternative plan (process) which is a target to be corrected. FIG. 17 illustrates an example of selection of a target plan to be corrected. For example, as illustrated in FIG. 17, the corrected alternative plan suggestion unit 16 selects the most important alternative plan (process 1) of the group β, which is the majority group, as the target plan to be corrected. The corrected alternative plan suggestion unit 16 corrects the target plan to be corrected in a direction that satisfies the members of the group α according to the alternative plan correction vector.

For example, the corrected alternative plan suggestion unit 16 assumes a process, on which evaluation is not performed through a survey, as the corrected alternative plan. The corrected alternative plan suggestion unit 16 estimates difference in directivities between the evaluation value of the assumed corrected alternative plan and the evaluation value of the target plan to be corrected based on the difference in tasks between the assumed corrected alternative plan and the target plan to be corrected and the influence degree evaluation for each of the tasks. For example, as illustrated in the table 60 of FIG. 6, the process 2 on which survey is not performed is assumed as the corrected alternative plan from among the processes acquired by the process acquisition unit 11. The difference in tasks between the process 2 and the process 1 is that “gist preparation” “exists” in the process 2. The directions and magnitudes of evaluation values in a case where the process 1 is corrected to the process 2 may be acquired as follows using the evaluation influence degree (refer to reference number 76 of FIG. 15) when the task “gist preparation” “exists”.

rapidity:(+1×−1.025)=−1.025

reliability:(+1×4.164)=+4.164

educational property:(+1×0.455)=+0.455

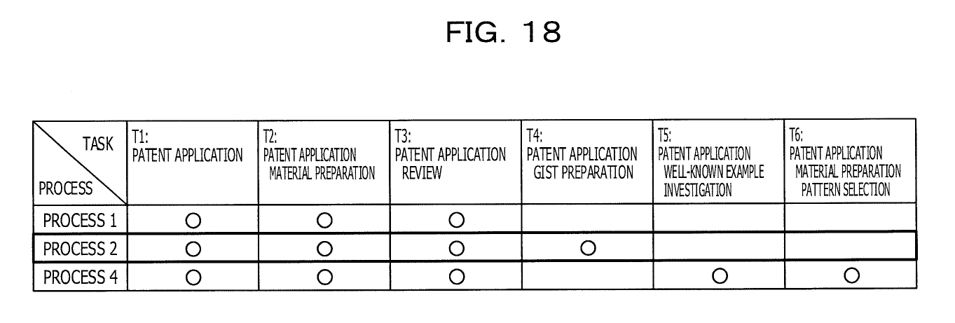

In the above, “+1” expresses that the task “gist preparation” “exists”. When the “gist preparation” and “does not exist” are used as reference, “−1” may be used. FIG. 18 illustrates an example of a corrected alternative plan. When the direction and the magnitude of the change in the evaluation values between the assumed corrected alternative plan and the target plan to be corrected coincide with the alternative plan correction vector, the corrected alternative plan suggestion unit 16 selects the assumed corrected alternative plan as the corrected alternative plan to be suggested to the members as illustrated in FIG. 18. This is substantially the same as a case where a corrected alternative plan being prepared by adding the task “gist preparation”, which is selected based on the evaluation influence degree for each of the tasks, to the target plan to be corrected. Whether or not the direction and the magnitude of the change in the evaluation values between the assumed corrected alternative plan and the target plan to be corrected coincide with the alternative plan correction vector may be determined based on whether or not the degree of similarity of cosines between the alternative plan correction vector and a vector indicating the direction and the magnitude of the change in the evaluation values between the assumed corrected alternative plan and the target plan to be corrected is equal to or greater than a certain value.

The corrected alternative plan suggestion unit 16 displays the selected corrected alternative plan on the display apparatus which may be used by the members who perform the consensus building.

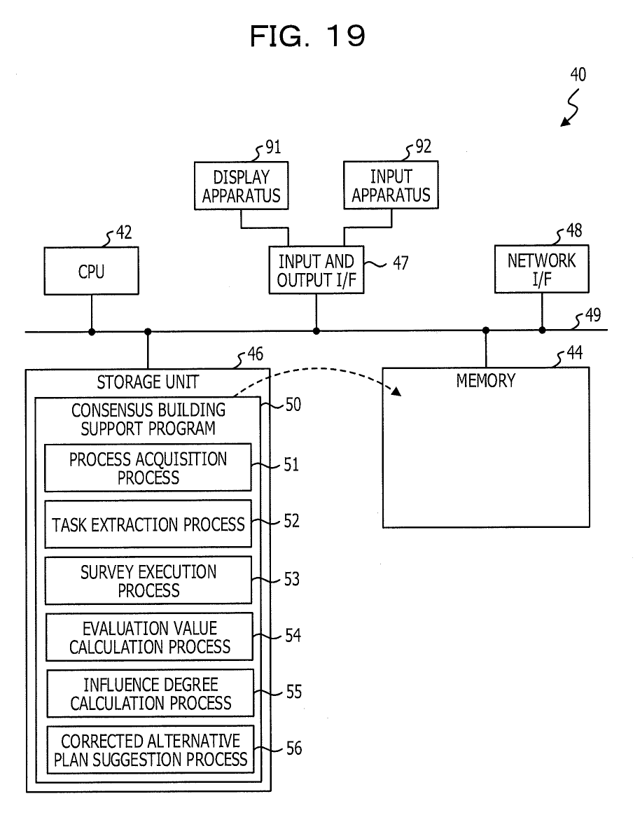

FIG. 19 illustrates an example of a consensus building support apparatus. The consensus building support apparatus 10 illustrated in FIG. 19 may be, for example, a computer 40. The computer 40 includes a CPU 42, a memory 44, anon-volatile storage unit 46, an input and output interface (I/F) 47, and a network I/F 48. The CPU 42, the memory 44, the storage unit 46, the input and output I/F 47, and the network I/F 48 are coupled to each other through a bus 49. The CPU 42 may be a processor.

The computer 40 is coupled to a display apparatus 91 and an input apparatus 92 through the input and output I/F 47. In the display apparatus 91, the survey screen 62 as illustrated in FIG. 7 is displayed, and an answer to the survey is input in such a way that the member operates the input apparatus 92. The display of the survey screen 62 and the input of the answer to the survey may be performed using a personal computer or the like which is coupled to a network through the network I/F 47.

The storage unit 46 may include a hard disk drive (HDD), a flash memory, or the like. In the storage unit 46 as a storage medium, a consensus building support program 50 which causes the computer 40 to function as the consensus building support apparatus 10 is stored. The CPU 42 reads the consensus building support program 50 from the storage unit 46, deploys the consensus building support program 50 in the memory 44, and sequentially executes processes included in the consensus building support program 50. The consensus building support program 50 may be downloaded to the storage unit 46 or the memory 44 through the network I/F 48.

The consensus building support program 50 includes a process acquisition process 51, a task extraction process 52, a survey execution process 53, an evaluation value calculation process 54, an influence degree calculation process 55, and a corrected alternative plan suggestion process 56. The CPU 42 operates as the process acquisition unit 11 illustrated in FIG. 1 by executing the process acquisition process 51. The CPU 42 operates as the task extraction unit 12 illustrated in FIG. 1 by executing the task extraction process 52. The CPU 42 operates as the survey execution unit 13 illustrated in FIG. 1 by executing the survey execution process 53. The CPU 42 operates as the evaluation value calculation unit 14 illustrated in FIG. 1 by executing the evaluation value calculation process 54. The CPU 42 operates as the influence degree calculation unit 15 illustrated in FIG. 1 by executing the influence degree calculation process 55. The CPU 42 operates as the corrected alternative plan suggestion unit 16 illustrated in FIG. 1 by executing the corrected alternative plan suggestion process 56. The computer 40 which executes the consensus building support program 50 functions as the consensus building support apparatus 10.

The consensus building support apparatus 10 may include, for example, a semiconductor integrated circuit such as an Application Specific Integrated Circuit (ASIC).

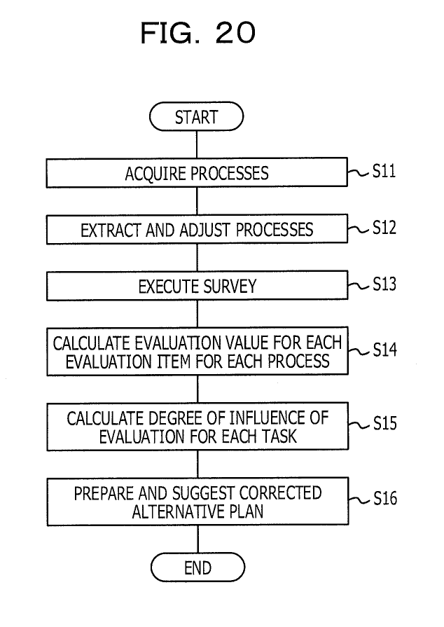

FIG. 20 illustrates an example of a consensus building support process.

In an operation S11 of the consensus building support process illustrated in FIG. 20, the process acquisition unit 11 acquires a plurality of process instances from the process instance DB 21. The process acquisition unit 11 groups the plurality of process instances, which have been acquired, for each of the process instances having the same type of the tree structure of tasks, and acquires processes from each of the groups one by one.

In operation S12, the task extraction unit 12 disassembles each of the plurality of processes acquired by the process acquisition unit 11 for each of the tasks, removes overlapping tasks, and extracts tasks included in the plurality of processes. The task extraction unit 12 readjusts the tasks included in each of the processes, and readjusts different tasks between each of the processes.

In operation S13, the survey execution unit 13 sets processes acquired by the process acquisition unit 11 to the candidates for the alternative plan which are the consensus building targets, and executes a survey in order to acquire evaluation for each of the plurality of candidates. The survey execution unit 13 simultaneously executes a survey in order to acquire information about tasks which affect the evaluation for each of the plurality of candidates while executing the survey in order to acquire evaluation for each of the plurality of candidates. For example, the survey execution unit 13 performs control such that the survey screen 62 illustrated in FIG. 7 is displayed on the display apparatus 91.

In operation S14, the evaluation value calculation unit 14 acquires the importance degree information 23 and evaluation of each of the members for each of the plurality of candidates as the survey results 24. The evaluation value calculation unit 14 calculates the evaluation value for each of the processes for each of the evaluation items of the group α, and calculates the evaluation value for each of the processes of the group α based on the matrix product with the importance degree 69 for each of the evaluation items of the group α acquired from the importance degree information 23.

In operation S15, the influence degree calculation unit 15 acquires information about tasks which affect the evaluation performed by each of the members for each of the plurality of candidates as the survey results 24. The influence degree calculation unit 15 calculates the influence degree for each of the tasks for each of the evaluation items of the group α. The influence degree calculation unit 15 multiplies each of the calculated values by the importance degree of the evaluation item corresponding to the importance degree 69 for each of the evaluation items of the group α acquired from the importance degree information 23, and calculates the evaluation influence degree 76 for each of the processes of the group α.

In operation S16, the corrected alternative plan suggestion unit 16 assumes a process which does not execute evaluation according to the survey as a corrected alternative plan. When the direction and the magnitude of the change in the evaluation values of the assumed corrected alternative plan and the target plan to be corrected coincide with the alternative plan correction vector, the corrected alternative plan suggestion unit 16 selects the corrected alternative plan which is assumed as the corrected alternative plan to be suggested to the member. The corrected alternative plan suggestion unit 16 displays the selected corrected alternative plan on a display apparatus which may

be used by the member who performs the consensus building, and the consensus building support process is ended.

According to the consensus building support apparatus, the influence degree which affects the evaluation of the process is calculated for each of the tasks included in the process. When the process which is the candidate of the alternative plan is corrected and the corrected alternative plan is prepared, a task to be added to or removed from the process which is the target plan to be corrected is selected based on the influence for each of the tasks. The corrected alternative plan, which causes the evaluation value to generate desired change, is prepared. Therefore, the number of times that the correction of the alternative plan is repeated by trial and error is reduced, and thus the efficiency of consensus building may be achieved.

Information related to tasks which affect evaluation for processes is acquired through the survey, and the influence degree for each of the tasks is calculated using the information. Even in a case in which the number of evaluated processes<<the number of tasks is established, the influence degree for each of the tasks may be appropriately calculated.

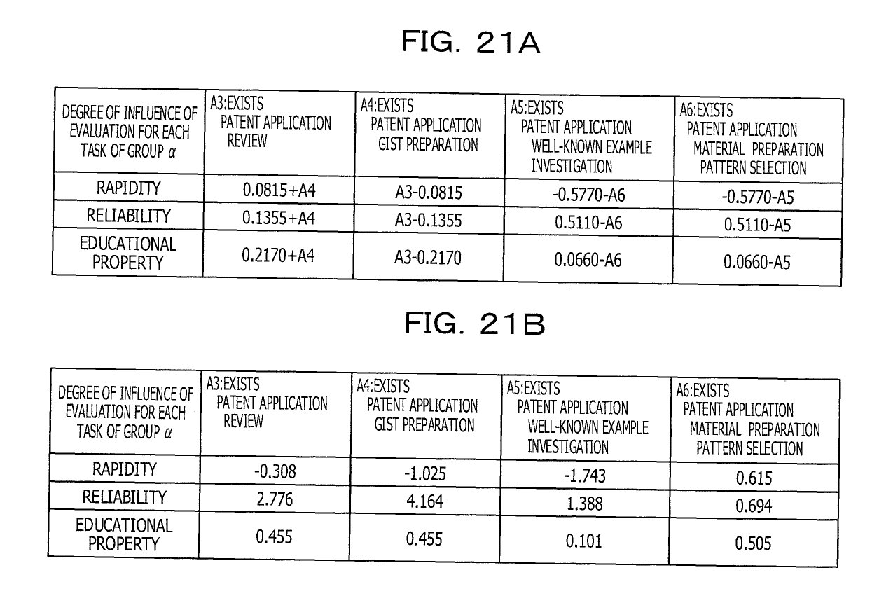

FIGS. 21A and 21B illustrate an example of the evaluation influence degree. For example, as illustrated in FIG. 21A, when the influence degree for each of the tasks is calculated based on the evaluation for the alternative plan (process), for example, based on only the evaluation for the alternative plan (process), the influence (directional difference) between tasks may not be distinguished further than the number of evaluated alternative plans. Therefore, only the influence for each combination of a plurality of tasks is calculated, and thus the influence degree for each of the tasks may be indefinite. Therefore, in FIG. 21A, for example, when correction in which the tasks “well-known example investigation” and “pattern selection” are simultaneously added is performed, influence on the evaluation values due to the addition of the tasks may be estimated. For example, only when correction in which the tasks “well-known example investigation” and “pattern selection” are simultaneously added is performed, the influence to the evaluation values due to the addition of the tasks may be estimated. For example, in a corrected alternative plan in which only the task “well-known example investigation” or the task “pattern selection” is added, how the evaluation values is changed due to the addition of the task may not be estimated. Therefore, a corrected alternative plan in order to realize consensus building efficiency may not be suggested.

As illustrated in FIG. 21B, when information related to tasks which affect evaluation for the processes is used, the influence degree for each of the tasks may be calculated in detail regardless of the number of evaluated alternative plans. Therefore, for example, even in a case of the corrected alternative plan to which only the task “well-known example investigation” is added, the influence to the evaluation value due to the addition of the task may be estimated. For example, a detailed corrected alternative plan in which only a single task is added or removed may be prepared.

A survey in order to acquire information related to tasks which affect the evaluation of the processes is simultaneously performed with a process evaluation survey. Therefore, the increase in load of the survey may be reduced.

When the corrected alternative plan is prepared, a process on which a survey has not been performed may be assumed as the corrected alternative plan. For example, from among the candidates for all of the corrected alternative plans which may be prepared by adding or removing a task to or from the target plan to be corrected, an alternative plan, in which the directivity of change in the evaluation values with regard to the target plan to be corrected is close to the alternative plan correction vector, may be prepared as the corrected alternative plan.

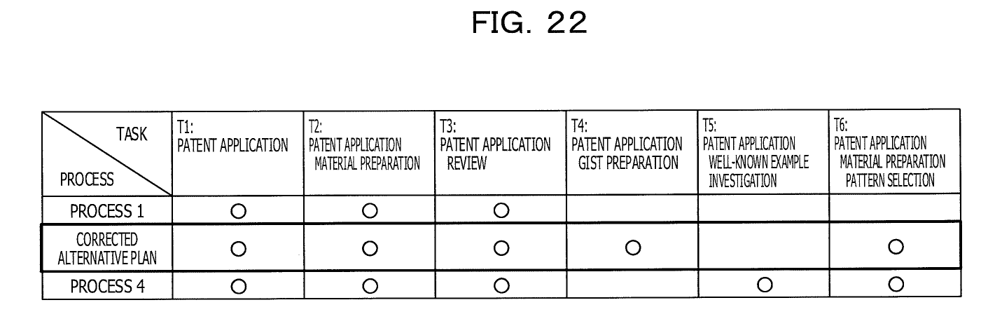

For example, when the process 1 is selected as the corrected subject plan, the combination of tasks which are added to or removed from the process 1 is 2̂4−1=15. For example, the candidates for the corrected alternative plan may be 15. For each of all of the candidates, a vector, which indicates the direction and the magnitude of the change in the evaluation values, is calculated based on the difference in task with the process 1 and the evaluation influence degree for each of the tasks. Using the similarity degree of the cosine between the alternative plan correction vector and each of the calculated vectors, as illustrated by the alternative plan correction vector, candidates in which rapidity is reduced and reliability is improved are selected as the corrected alternative plan. FIG. 22 illustrates an example of a corrected alternative plan. For example, when a vector of a candidate, in which the tasks “gist preparation” and “pattern selection” are added to the process 1, has the highest degree of coincidence with the alternative plan correction vector, the candidate is set to the corrected alternative plan, as illustrated in FIG. 22.

The number of suggested corrected alternative plans is not limited to one. Each of the candidates is ranked based on the degree of coincidence with the alternative plan correction vector, and a certain number of candidates of a high rank may be suggested as the corrected alternative plan. All or some of the candidates may be suggested together with the directionality of the change in the evaluation values from the corrected subject plan.

For example, an influence may be calculated using Equation (1). The calculation method may be changed according to the accuracy of the survey results when the information, related to the tasks which affect the evaluation of the processes, is acquired. The accuracy of the survey results may be the degree of contradiction which exists in the answers. For example, when the number of evaluated processes>the number of tasks is established, an algebraic equation or multiple regression analysis may be used as another method of calculating influence. In addition, the influence for each of the tasks may be calculated by appropriately combining the above-described calculation method and the calculation method using an algebraic equation and multiple regression analysis.

On the assumption that the common work process is established, a process which includes at least one task may be set to a target to be processed. The above-described technology may be applied to consensus building for a case which includes decomposable elements.

The consensus building support program 50 may be stored (installed) in the storage unit 46 in advance or may be provided in a form of being recorded in a storage medium such as a CD-ROM or a DVD-ROM.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A consensus building support method comprising:
acquiring information related to one or more elements that affect a plurality of evaluations for each of a plurality of candidates for an alternative plan which includes at least one element and corresponds to a target of a consensus building;
calculating, by a computer, an influence degree of the plurality of evaluations for each of the one or more elements based on the plurality of evaluations and the information; and
creating corrected candidates by adding or removing a selected element which is selected based on the influence degree for each of the one or more elements to or from one of the plurality of candidates.

2. The consensus building support method according to claim 1, further comprising:
extracting the element by disassembling each of the plurality of candidates.

3. The consensus building support method according to claim 1, further comprising:
calculating, when the plurality of evaluations includes an evaluation for a plurality of evaluation items, the influence degree of each of the plurality of evaluation items for each of the one or more elements.

4. The consensus building support method according to claim 1, further comprising:
acquiring, when acquiring the plurality of evaluations from a plurality of members who perform consensus building, the information.

5. The consensus building support method according to claim 1, further comprising:
controlling a display apparatus such that surveys for acquiring the plurality of evaluations and the information are displayed on a screen.

6. The consensus building support method according to claim 1, further comprising:
acquiring a corrected vector for changing an evaluation of one of the plurality of candidates becomes a certain evaluation; and
selecting an element to be added or removed to or from one of the plurality of candidates such that a degree of similarity between a vector, which is expressed by the one of the plurality of candidates and the corrected candidates, and the corrected vector is equal to or greater than a value.

7. A consensus building support apparatus comprising:
a storage configured to store a consensus building support program; and
a processor configured to preform operations based on the consensus building support program,
wherein the operations includes:
acquiring information related to one or more elements that affect a plurality of evaluations for each of a plurality of candidates for an alternative plan which includes at least one element and corresponds to a target of a consensus building;
calculating an influence degree of the plurality of evaluations for each of the one or more elements based on the plurality of evaluations and the information; and
creating corrected candidates by adding or removing a selected element which is selected based on the influence degree for each of the one or more elements to or from one of the plurality of candidates.

8. The consensus building support apparatus according to claim 7,
wherein the operations further include:
extracting the element by disassembling each of the plurality of candidates.

9. The consensus building support apparatus according to claim 7,
wherein the operations further include:
calculating, when the plurality of evaluations includes an evaluation for a plurality of evaluation items, the influence degree of each of the plurality of evaluation items for each of the one or more elements.

10. The consensus building support apparatus according to claim 7,
wherein the operations further include:
acquiring, when acquiring the plurality of evaluations from a plurality of members who perform consensus building, the information.

11. The consensus building support apparatus according to claim 7, further comprising:
a display apparatus configured to display surveys for acquiring the plurality of evaluations and the information on a screen.

12. The consensus building support apparatus according to claim 7,
wherein the operations includes:
acquiring a corrected vector for changing an evaluation of one of the plurality of candidates becomes a certain evaluation; and
selecting an element to be added or removed to or from one of the plurality of candidates such that a degree of similarity between a vector, which is expressed by the one of the plurality of candidates and the corrected candidates, and the corrected vector is equal to or greater than a value.

13. A consensus building support system comprising:
an interface coupled to a network;
a first memory;
a second memory configured to deploy a program from the interface or the first memory; and
a processor configured to execute the program in the second memory,
wherein the processor performs, based on the program, operations of:
acquiring information related to one or more elements that affect a plurality of evaluations for each of a plurality of candidates for an alternative plan which includes at least one element and corresponds to a target of a consensus building;
calculating an influence degree of the plurality of evaluations for each of the one or more elements based on the plurality of evaluations and the information; and
creating corrected candidates by adding or removing a selected element which is selected based on the influence degree for each of the one or more elements to or from one of the plurality of candidates.

14. The consensus building support system according to claim 13,
wherein the operations further include:
extracting the element by disassembling each of the plurality of candidates.

15. The consensus building support system according to claim 13,
wherein the operations further include:
calculating, when the plurality of evaluations includes an evaluation for a plurality of evaluation items, the influence degree of each of the plurality of evaluation items for each of the one or more elements.

16. The consensus building support system according to claim 13,
wherein the operations further include:
acquiring, when acquiring the plurality of evaluations from a plurality of members who perform consensus building, the information.

17. The consensus building support system according to claim 13, further comprising:
a display apparatus configured to display surveys for acquiring the plurality of evaluations and the information on a screen.

18. The consensus building support system according to claim 13,
wherein the operations includes:
acquiring a corrected vector for changing an evaluation of one of the plurality of candidates becomes a certain evaluation; and
selecting an element to be added or removed to or from one of the plurality of candidates such that a degree of similarity between a vector, which is expressed by the one of the plurality of candidates and the corrected candidates, and the corrected vector is equal to or greater than a value.
